(19) United States
(12) Patent Application Publication
(10) Pub. No.: US 2001/0031029 A1
(43) Pub. Date: Oct. 18, 2001

(54) Method and apparatus for the generation of thermal energy

(76) Inventor: Ubaldo Mastromatteo, Cornaredo (IT)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/837,905

(22) Filed: Apr. 18, 2001

Related U.S. Application Data
(63) Continuation of application No. 09/077,463, filed on Nov. 30, 1998, now abandoned.

(30) Foreign Application Priority Data
Nov. 2, 1996 (IT) MI95A002503
Nov. 26, 1996 (IT) PCT/IT96/00224

(51) Int. Cl. G21J 1/00; G21B 1/00

(52) U.S. Cl. 376/100

(57) ABSTRACT

An apparatus for the generation of thermal energy includes: a) a first quantity in solid form of a first material suitable to absorb hydrogen with ensuing generation of thermal energy; b) a second quantity in solid form of a second material suitable to release hydrogen at a temperature higher than a prefixed temperature, at least partly in contact with said first quantity; and c) a third quantity in solid form of a third material, suitable for the generation of thermal energy when it is submitted to the passage of electric current, so located as to be thermally coupled with said second quantity.

### CROSS-REFERENCE TO RELATED APPLICATIONS

This is a continuation of U.S. patent application Ser. No. 09/077,463, filed on Nov. 30, 1998.

### TECHNICAL FIELD

This invention relates to a method and an apparatus for the generation of thermal energy.

### BACKGROUND OF THE INVENTION

In the experiments made till now several materials capable of absorbing hydrogen and its isotopes have been used successfully for the realization of the electrodes, among which: palladium, titanium, platinum, nickel, niobium.

In the experiments made till now, the deuterium was always obtained from a gaseous state fuel, for instance gaseous mixes of hydrogen or fluid fuels, for instance solutions of electrolytic compounds of hydrogen in heavy water; the drawback of these “fuels” lies in the dissipation of the hydrogen.

### SUMMARY OF THE INVENTION

An embodiment of this invention provides a method and the related apparatus capable of effectively generating thermal energy.

By utilizing a solid form material suitable to release hydrogen when it reaches a temperature higher that a prefixed temperature, putting it in contact with another solid form material suitable to absorb hydrogen with ensuing generation of thermal energy, and heating it until it has overcome said prefixed temperature, there is generation of thermal energy by the other material, which generation lasts in the time, and its quantity is remarkable, as hydrogen cannot easily escape in solid materials and the working temperature threshold is very high and corresponds to the fusion of one of the solid form materials.

The invention will be more clearly stressed by the following description, considered together with the attached drawings, wherein:

### BRIEF DESCRIPTION OF THE DRAWINGS

FIG. 1 shows schematically the section of a structure of part of a first reactor and of a first apparatus according to this invention.

FIG. 2 shows schematically the section of a structure of part of a second reactor and of a second apparatus according to this invention.

FIG. 3 shows schematically the section of a thermopile of a known type utilizable in the reactor of FIG. 2.

### DETAILED DESCRIPTION OF THE INVENTION

During the fabrication of integrated electronic circuits, some materials, such as silicon nitride, are enriched in hydrogen and cause degradations in performance. Such a phenomenon is described, for instance, in S. Manzini's article “Active doping instability in n+−p silicon surface avalanche diodes”, Solid-State Electronics, Vol. 2, pp. 331-337, 1995 and in the articles mentioned in the references.

It has then been thought to exploit usefully this “noxious” property of such materials.

A process step, typical of the fabrication techniques of the integrated electronic circuits, which leads to the formation of hydrogen-rich materials is the PECVD (Plasma Enhanced Chemical Vapor Deposition); details on this process step and also on all the fabrication techniques of silicon-based integrated electronic circuits may be drawn from S. M. Sze's book “VLSI Technology”, McGraw-Hill, 1988; there are in addition fabrication techniques that are characteristic of germanium and gallium arsenide-based integrated electronic circuits which are well known in the literature.

A typical chemical reaction between hydrogen compounds using the PECVD technique is the following one:

AHₙ+BHₘ→AₓB_{y}+A−Hⱼ+B−Hₖ+H₂ [1]

Such oxidoreduction reaction [1] takes place from leftside to rightside if we reach a rather high temperature T1, for instance 400° C., and if we cause the two leftside reagents to be in the plasma phase instead than in the gaseous phase; at such “low” temperature T1, the reaction [1] is not complete and stoichiometric and many bonds remain therefore between hydrogen and the A and B elements; generally, these bonds are single, i.e., “j” and “k” are equal to one; from reaction [1] a solid composition is obtained that has a high content of chemically bound hydrogen (and therefore of deuterium and tritium if they are present in the starting materials) and of gaseous state hydrogen, which does not remain in high amount in the composition.

If the so obtained solid composition is heated afterwards (even after a possible cooling at room temperature) up to a temperature T2 higher than the previous one, for instance 800° C., reaction [1] becomes complete and stoichiometric, i.e. the following reaction takes place:

A−Hⱼ+B−Hₖ→AₓB_{y}+H₂ [2]

with release of the hydrogen contained.

At temperatures comprised between T1 and T2 only the more weakly bound atoms will be released.

Of course, temperatures T1 and T2 depend on the A and B elements utilized; besides, it must be taken into account that there are no critical values which cause abrupt variations in the reaction speed for reactions [1] and [2].

Therefore, a method according to an embodiment of this invention proposes to utilize a first quantity in solid form of a first material suitable to absorb hydrogen with ensuing generation of thermal energy, and to utilize a second quantity in solid form of a second material suitable to release hydrogen when it is at a temperature higher than a prefixed temperature, to put in contact at least partly to one another said first and said second quantity, and to heat at the start at least said second quantity, at least until it has exceeded said prefixed temperature in at least one part; the starting heating may also be caused by the environment where the two quantities are placed.

The starting heating causes in the second quantity the release of some hydrogen; such hydrogen will move, for instance by diffusion in the solid state, in the second quantity and pass, at least partly into the first quantity, as this one is in contact with the second quantity.

The first quantity absorbs hydrogen and starts generating thermal energy, because of the presumed nuclear fusion reactions, and then starts heating.

As the two quantities are in contact, the second quantity will be heated by the first quantity and therefore the process of hydrogen release goes on; as a consequence, the first quantity goes on heating. If the first quantity should not be in condition of heating the second quantity sufficiently, the “starting” heating can be expected to go on, for instance, for the whole duration of the process of thermal energy generation.

Of course, the aforementioned silicon nitride-based solid composition is only one of the possible second materials that stresses such release properties; of course, such second materials may be produced according to different techniques, among which the PECVD.

In the same way, as first material one can choose among: palladium, titanium, platinum, nickel, and alloy thereof, and any other material showing such absorption property.

The fact that the starting heating of the second quantity may involve, in some cases, a starting heating also of the first quantity through their contact, is an advantage as, in such cases, the hydrogen absorption by the first quantity is spurred; such heating may also be spurred, if necessary, by a suitable arrangement of the materials and the thermal energy source.

Relying on the spontaneous movement of hydrogen in the second quantity towards the first quantity may lead to an insufficient generation of thermal energy.

To obviate this drawback, it is convenient that at least part of the second quantity be submitted to an electric field with field lines having such shape and direction as to spur the movement of the nuclei of such hydrogen released in the second quantity towards the first quantity.

The intensity of the electric field can be fixed beforehand on the basis of the thermal power wished.

If the thermal power generated is not suitably removed, the temperature of the two quantities will continue to increase until they are melted and the apparatus is destroyed; should one wish to obtain different thermal powers at different times, controlling through the intensity of the electric field the thermal energy generated is very advantageous; through field inversion it is even possible to cancel the effect of the spontaneous movement of hydrogen, and therefore to inhibit entirely the generation of thermal energy.

The so generated thermal energy can then be utilized as such or converted into other forms of energy in a well known way.

With reference to the case in which the second material is a silicon nitride-based solid composition, hydrogen and its isotopes that are released through reaction [2] are absorbed by the first absorbing material with good efficiency, as the two materials are in contact with one another and both of them are solid.

It is important that the concentration of hydrogen in the second material, in terms of atoms per cubic centimeter, be sufficient to originate an appreciable number of fusion phenomena per volume unit of the first material.

In the case of silicon nitride and nickel, a concentration of 10²² may be chosen for the hydrogen in the silicon nitride and the nitride mass may be caused to be 9 times greater than the nickel mass; in this way, the number of hydrogen atoms that can be released is about equal to the number of nickel atoms available; in fact, the density of nickel is equal to 9×10²².

Actually, to the purposes of the use as solid fuel, the presence of the AₓB_{y} in the solid composition is not strictly indispensable; what matters is the presence of A−Hⱼ+B−Hₖ: therefore, it would be theoretically possible to utilize only either A−Hⱼ or B−Hₖ.

Of course, one cannot exclude the presence in the solid composition of other chemical elements or compounds which might not to take part, absolutely or to a relevant extent, in the chemical reaction between the A, B, H elements.

To the purposes of the use as solid fuel it is of the essential to cause reaction [1] not to complete in reaction [2], so as to trap much hydrogen in the resulting solid composition; of course, should some not chemically bound hydrogen be trapped in the composition but, for instance, in atomic and/or molecular and/or ionic form, this would be no problem, but on the contrary an advantage, as surely it would be released once the composition has been heated up to a temperature higher than T1.

With silicon nitride and utilizing the aforementioned PECVD techniques, hydrogen concentrations equal to 10²² atoms per cubic centimeter are easily reached.

The above set forth method can be realized by means of an apparatus comprising:

a) a first quantity in solid form of a first material suitable to absorb hydrogen with ensuing generation of thermal energy, and

b) a second quantity in solid form of a second material suitable to release hydrogen when it reaches a temperature higher than a prefixed temperature, at least partly in contact with the first quantity.

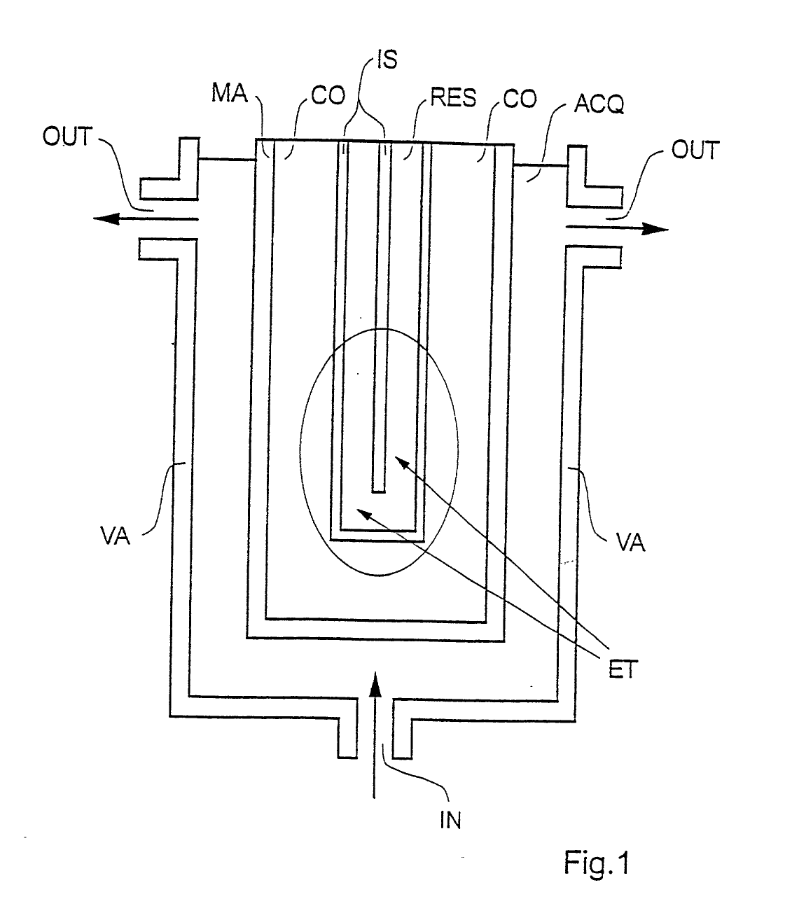

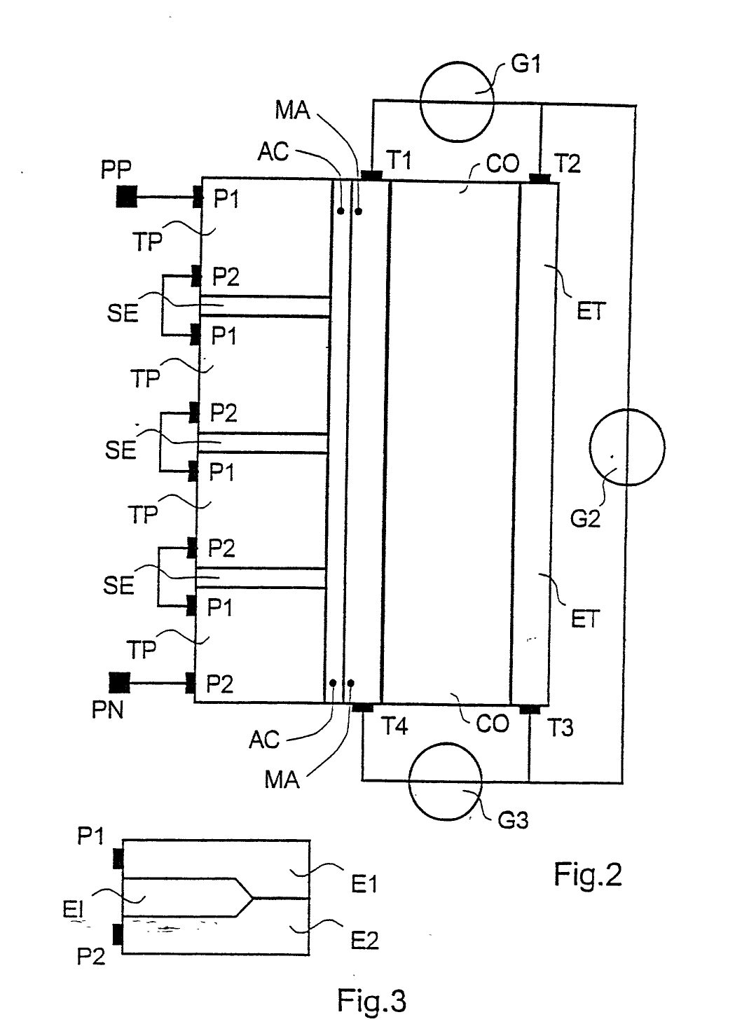

With reference to FIGS. 1 and 2, the first quantity is indicated by MA, while the second quantity is indicated by CO.

Said apparatus may advantageously and furtherly comprise thermal elements ET suitable to heat at the start at least the second quantity CO, at least until it has exceeded such prefixed temperature at least in one part.

Advantageously, the thermal elements ET may also be expected to be such as to heat at least at the start also the first quantity MA to a considerable extent; of course it is practically impossible to avoid completely the heating of the first quantity MA, as this is in contact with the second quantity CO.

In both the embodiments of FIGS. 1 and 2, such heating is due to the passage of electric current; i.e., the thermal elements ET comprise a third quantity in solid form of a third material, suitable to generate thermal energy when it is submitted to the passage of electric current, so placed as to be thermally coupled with the second quantity CO; alternatively, the thermal elements ET may be thermally coupled with the first quantity MA and heat the second quantity CO indirectly; lastly, also the direct heating of both the MA and CO quantity may be taken into consideration.

In the embodiment of FIG. 1, the thermal elements ET are formed by a resistor RES contained in an insulator IS from electrically insulating and thermally conductive material, and are contained in the second quantity CO.

On the contrary, in the embodiment of FIG. 2, the thermal elements ET are located sideways on the second quantity CO and are constituted only by such third quantity of material, to which two terminals T2 and T3 are electrically coupled, which terminals are suitable also to be coupled to an electric energy generator G2 that may be located either inside or outside the apparatus according to the invention.

Of course, there are several alternatives by which the starting heating can be obtained, but less practical and less controllable.

An apparatus according to this invention may advantageously and furtherly comprise a third quantity in solid form of a third material, and at least a first terminal and a second terminal electrically coupled respectively to the first and the third quantity; if said first material and said third material are of a conductive or semiconductive type and if the mutual position of the first and the third quantity is such that at least part of the second quantity is concerned by an electric field when the first terminal and the second terminal are coupled to an electric energy generator, it is possible to control the movement of the hydrogen in the second quantity towards the first quantity.

This is the case of the embodiment of FIG. 2. More precisely, in said embodiment the third quantity, indicated by ET, performs both the function of thermal element and the function of polarization of the second quantity CO.

The first quantity MA and the third quantity ET form a condenser with two flat parallel plates in which a dielectric is interposed constituted by the second quantity CO. To the first quantity MA a terminal T1 is coupled, and to the third quantity ET two terminals T2 and T3 are coupled; between terminals T1 and T2 a voltage generator G1 is coupled for the polarization of the second quantity CO; between terminals T2 and T3 a voltage generator G2 is coupled for the heating of the second quantity CO.

In FIG. 2, to the first quantity MA another terminal T4 is coupled and between the terminals T3 and T4 another voltage generator G3 is coupled. As the potential of the third quantity ET changes from point to point because of generator G2 and as, in general, the first material and the third material are different, it may be important to check, trough generator G3, the intensity of the electric field and therefore the polarization of the second quantity CO when the position changes, for instance to obtain a uniform generation of thermal energy in the first quantity MA. Of course, the utilization of more generators may be taken into consideration both to couple different points of the first quantity MA, and to couple different points of the third quantity ET, as well as to couple points of the first and the third quantities.

Advantageously, there may be provided in the apparatus an electric control system—not shown in FIG. 2—suitable to control at least the difference of potential between the first terminal T1 and the second terminal T2, to control the overall thermal energy generated.

The apparatus for the generation of thermal energy described above is advantageously applied in a cold nuclear fusion reactor, considered as a complete plant capable of generating energy for human utilization; the apparatus for the generation of thermal energy constitutes therefore its heart; FIGS. 1 and 2 show only the essential part of two reactors of such type, while other components lack, such as: vapor turbines, monitoring and alarm systems, mechanical infrastructures, etc., well known in the field of energy generation.

One of the advantages of the utilization in a reactor of an apparatus according to this invention lies in that said apparatus can reach, if one so wishes, rather high temperatures (more than 800° C.), and therefore the yield of a possible thermodynamic cycle of transformation of heat into work may be rather high.

In FIG. 1 the first quantity MA has the form of a container, for instance cylindrical; such container is shown immersed in a tank VA suitable to contain, for instance water ACQ, and in which cool water can flow through an inlet IN, and once heated by contact with the container MA, it can flow out through outlets OUT.

In FIG. 2 the first quantity MA has the form of a flat plate and is placed sideways on a converter of thermal energy into electric energy, suitable to convert at least part of the thermal energy generated by the first quantity MA.

In FIG. 2 the converter comprises a thermopile system so located that its hot contact regions are thermally coupled with at least the first quantity MA.

The thermopile system comprises four thermopiles TP, provided each with a first terminal P1 and a second terminal P2, serially connected with one another; terminal P1 of the first thermopile TP is connected to a positive terminal PP of the converter; terminal P2 of the last thermopile TP is connected to a negative terminal PN of the converter. The thermopiles TP are electrically separated from one another through spacers SE from electrically insulating material, while they are thermally coupled to the first quantity MA through a coupler AC from electrically insulating and thermally conductive material.

Thermopiles are well known devices which operate generally by exploiting the Seebeck effect.

FIG. 3 shows a schematic section of a thermopile TP; this comprises a first element E1 of a first electric conductive material shaped as a small plate, a second element E2 of a second electric conductive material, other than the first one, and an insulating element EI of electrically insulating material shaped as a small plate; element E1 is superposed to element EI which is superposed to element E2; elements E1 and E2 are in electric contact with one another at a first extremity, called region of hot contact, while at the second extremity, called region of cold contact, they present respectively the first terminal P1 and the second terminal P2. If the first extremity of elements E1 and E2 is brought to a temperature higher than the temperature of their second extremity, a difference of potential creates between terminals P1 and P2, generally of the order of hundreds millivolts, which depends on the difference of temperature. The materials utilizable for the elements E1 and E2 are well known in the literature.

1. An apparatus for the generation of thermal energy comprising:
a first quantity in solid form of a first material suitable to absorb hydrogen with ensuing generation of thermal energy;
a second quantity in solid form of a second material that includes hydrogen and is suitable to release hydrogen when it reaches a temperature higher than a prefixed temperature, the second quantity being in contact with the first quantity;
thermal elements suitable to heat at least said second quantity at least until it has exceeded said prefixed temperature at least in one part; wherein said thermal elements comprise a third quantity in solid form of a third material, suitable to generate thermal energy when it is submitted to the passage of electric current, so placed as to be thermally coupled to said first and/or said second quantity;
a first electric energy generator;
a first terminal and a second terminal electrically coupled to said first electric energy generator and respectively electrically coupled to said first and said third quantities, wherein said first and said third materials are of a conductive or semiconductive type, and wherein the mutual position of said quantities is such that at least part of the second quantity is acted on by an electric field when said first terminal and said second terminal are coupled to said first electric energy generator; and
a temperature sensor coupled to said first quantity and to said first electric energy generator so as to cause said first electric energy generator to modulate the electric field based on the temperature of the first quantity.

2. The apparatus according to claim 1, wherein said thermal elements are suitable to heat at least part of said first quantity.

3. The apparatus according to claim 1, further comprising:
a third terminal electrically coupled to said third quantity; and
a second electric energy generator coupled between said second and third terminals.

4. The apparatus according to claim 1, wherein said first electric energy generator and said temperature sensor together comprise an electric control system suitable to control at least the difference of potential between said first terminal and said second terminal.

5. The apparatus according to claim 5, wherein the temperature sensor includes a converter of thermal energy into electric energy, suitable to convert at least part of the thermal energy generated by said first quantity.

6. The apparatus according to claim 6, wherein said converter comprises a thermopile system having hot contact regions that are thermally coupled to at least said first quantity.

7. The reactor according to claim 6, wherein said converter comprises a thermopile system having hot contact regions that are thermally coupled to at least said first quantity.

8. An apparatus for the generation of thermal energy comprising:
a first member composed of a first solid material which absorbs hydrogen and generates thermal energy therefrom;
a second member composed of a second solid material which includes and releases hydrogen, said second member being in contact with the first member;
a third member composed of a third solid material in contact with the second member, said third member being a solid body which generates heat when an electric current passes therethrough;
an electrical field generator having a first terminal connected to the first member and a second terminal connected to the third member, the first and second terminals being positioned to cause an electric field to be generated across the second member, thereby causing hydrogen to be released from the second member for absorption by the first member; and
a temperature sensor coupled to the electrical field generator and thermally coupled to the first member, the temperature sensor being structured to cause the electrical field generator to modulate the electric field based on a temperature sensed by the temperature sensor.

9. The apparatus according to claim 8 wherein the first solid material is a semiconductor.

10. The apparatus according claim 8 wherein the third solid material is a semiconductor.

11. The apparatus according to claim 8 wherein the temperature sensor includes a thermopile located adjacent to the first solid material and thermally coupled to the first member so as to generate electric current based on the heat generated from the first member.

13. The apparatus according to claim 8 wherein said second material is silicon nitride.

14. The apparatus according to claim 13 wherein said first material includes nickel.

15. The apparatus according to claim 14 wherein the silicon nitride mass is more than 9 times greater than the nickel mass.

16. A method for generating thermal energy, comprising:
providing a first member composed of a solid material suitable to absorb hydrogen with ensuing generation of thermal energy;
placing a second member in contact with the first member, the second member being composed of a solid material that includes hydrogen which is released upon the second member reaching a prefixed temperature;
heating the second member at least until the second material reaches the prefixed temperature; and
applying an electric field to the second member, thereby causing the second member to release the hydrogen for absorption by the first member.
